(19) United States
(12) Patent Application Publication
(10) Pub. No.: US 2023/0133237 A1
(43) Pub. Date: May 4, 2023

(54) SUSPENDED LUMINAIRE WITH CURVED SOUND DAMPENING PANELS

(71) Applicant: SIGNIFY HOLDING B.V., EINDHOVEN (NL)

(72) Inventors: SOHANA K. ARNI, AURORA, CO (US); LAURIE BREED, AURORA, CO (US); ADAM J. CARAHALIOS, MORRISON, CO (US); CHRISTOPHER JOSEPH PAHL, DENVER, CO (US)

(21) Appl. No.: 17/793,590

(22) PCT Filed: Jan. 22, 2021
(86) PCT No.: PCT/EP2021/051436

§ 371 Date: Jul. 18, 2022

Related U.S. Application Data
(60) Provisional application No. 62/965,085, filed on Jan. 23, 2020.

(30) Foreign Application Priority Data
May 11, 2020 (EP) 20173852.3

(51) Int. Cl. E04B 1/84; F21S 8/06

(52) U.S. Cl. CPC E04B 1/84; F21S 8/061; F21Y 2115/10

(57) ABSTRACT

The invention relates to a suspended luminaire for providing sound dampening. The luminaire (100) has a first acoustic panel (105) and a second acoustic panel (120). The first acoustic panel (105) has a first curved shape, and the second acoustic panel (120) has a second curved shape, wherein the first curved shape is a mirror image of the second curved shape. The first top side (111) of the first acoustic panel (105) and the second top side (126) of the second acoustic panel (120) are separated by a top gap (150). The first bottom side (113) of the first acoustic panel (105) and the second bottom side (128) of the second acoustic panel (120) are separated by a bottom gap (156). The luminaire (100) further has a light module (160) that is attached proximal to the first bottom side (113) of he first acoustic panel (105) and proximal to the second bottom side (128) of the second acoustic panel (120).

### TECHNICAL FIELD

Embodiments of the technology relate generally to luminaires and more particularly to a suspended luminaire that provides sound dampening.

### BACKGROUND

A luminaire is a system for producing, controlling, and/or distributing light for illumination. Luminaires are often referred to as light fixtures. The lighting industry has been transitioning to using light emitting diodes as the light source in luminaires. As compared to incandescent and fluorescent light sources, light emitting diodes (LEDs) offer substantial potential benefit associated with their energy efficiency, light quality, and compact size. However, applying LEDs for use in lighting systems offers both challenges and opportunities. In some cases, LED luminaires can provide additional functions or benefits beyond supplying illumination light for an area.

### BRIEF DESCRIPTION OF THE FIGURES

Reference will now be made to the accompanying drawings, which are not necessarily drawn to scale, and wherein:

FIG. 1 illustrates a front perspective view of a suspended luminaire according to an example embodiment of the present disclosure;

FIG. 2 illustrates a side perspective view of the suspended luminaire of FIG. 1 according to an example embodiment of the present disclosure;

FIG. 3 illustrates an opposite side perspective view of the suspended luminaire of FIG. 1 according to an example embodiment of the present disclosure;

FIG. 4 illustrates a cross-sectional view of the suspended luminaire of FIG. 1 according to an example embodiment of the present disclosure; and

FIG. 5 is an exploded view of the suspended luminaire of FIG. 1 according to an example embodiment of the present disclosure.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different drawings designate like or corresponding but not necessarily identical elements.

### DETAILED DESCRIPTION OF EXAMPLE EMBODIMENTS

In the following paragraphs, example embodiments will be described in further detail with reference to the figures. In the description, well-known components, methods, and/or processing techniques are omitted or briefly described. Furthermore, reference to various feature(s) of the embodiments is not to suggest that all embodiments must include the referenced feature(s).

The example embodiments described herein relate to luminaires that are suspended from a ceiling or other mounting structure and comprise acoustic panels used for absorbing sound. The acoustic panels described herein have a unique shape to optimize the absorption of sound. It should be appreciated that the embodiments herein can also apply to other types of luminaires beyond suspended luminaires.

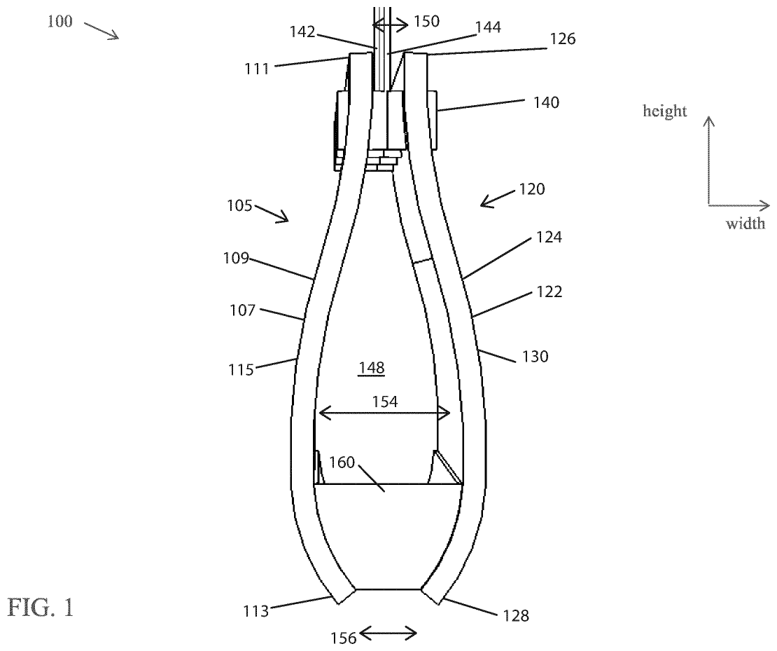

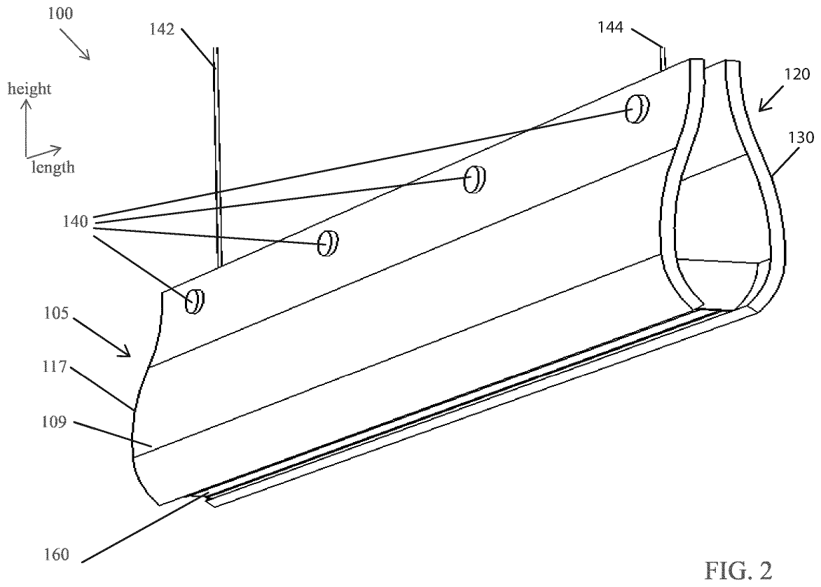

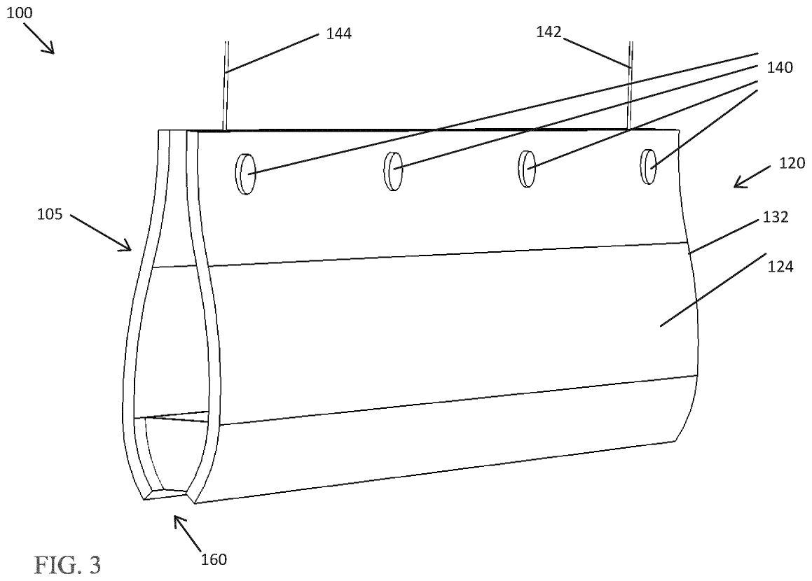

Referring now to FIGS. 1-5, a luminaire 100 is illustrated in accordance with an example embodiment of the present disclosure. Luminaire 100 comprises a first acoustic panel 105 and a second acoustic panel 120. The first and second acoustic panels 105, 120 can be joined along the top by at least one joining rod 140 and are joined along the bottom by a light module 160. In alternate example embodiments, the joining rods 140 can be omitted leaving the top portion between the first acoustic panel 105 and the second acoustic panel 120 completely open. One or more suspension cables, such as suspension cables 142 and 144, can be attached to the joining rods 140 for suspending the luminaire 100 from a ceiling or other support structure. In alternate example embodiments, the one or more suspension cables can be attached to the light module 160. The first and second acoustic panels 105, 120 and the light module 160 together define a cavity 148. The cavity 148 is open along the top of the luminaire 100 due to open spaces between the joining rods 140. The first acoustic panel 105 and second acoustic panel 120 are curved such that the luminaire 100 has a unique shape that can be described as a tear drop. In other words, as described further below, the luminaire 100 has a width along the top that is more narrow than the width along the bottom.

The acoustic panels can absorb sound which can be beneficial in large open areas or areas with significant noise. The acoustic panels can be made from one or more of a variety of materials known to be effective for absorbing sound such as foam, cork, felt, various polymers such as polyethylene terephthalate (“PET”), other porous materials, and combinations of the foregoing materials. In one example, PET can be softened by a heating process and pressed into curved shapes such as the shapes shown in FIGS. 1-5. In the example suspended luminaire 100 of FIGS. 1-5, there are two acoustic panels 105 and 120.

However, in other example embodiments, the luminaire can have other shapes and the number of acoustic panels will be determined by that shape.

The first acoustic panel 105 comprises two major surfaces bordered by narrow side surfaces. Specifically, the first acoustic panel 105 comprises a first inner major surface 107, a first outer major surface 109, a first top side 111, a first bottom side 113, a first proximal lateral side 115, and a first distal lateral side 117. Similarly, the second acoustic panel 120 comprises a second inner major surface 122, a second outer major surface 124, a second top side 126, a second bottom side 128, a second proximal lateral side 130, and a second distal lateral side 132. The first acoustic panel 105 and second acoustic panel 120 are arranged so that the inner major surface of each panel faces the inner major surface of the other panel.

As shown in FIGS. 1-5, the first and second acoustic panels 105, 120 have a curvature so that when the luminaire 100 is assembled, the cavity 148 within the luminaire 100 has varying widths. At the top of the luminaire 100, a top gap 150 located between the first inner major surface 107 and the second inner major surface 122 is the most narrow width of the cavity 148. Joining rods 140 can be located intermittently along the top gap 150, but open spaces between the joining rods 140 leave openings in the top portion of the luminaire 100. These one or more openings along the top gap 150 permit sound to travel into the cavity 148 where it can be absorbed by the first inner major surface 107 and the second inner major surface 122 thereby improving the sound absorption characteristics of the luminaire.

Moving downward from the top gap 150 as illustrated in FIGS. 1-5, the acoustic panels 105, 120 curve outward until the widest section of the cavity 148, which can be referred to as the major gap 154. Continuing downward from the major gap 154, the acoustic panels 105, 120 curve back inward until the bottom of the luminaire 100, at which the cavity 148 has a bottom gap 156. The bottom gap 156 is smaller than the major gap 154, but larger than the width of the top gap 150. The varying widths of the cavity 148 facilitate capture and absorption of unwanted sound that enters the cavity 148 through the top gap 150. Disposed in the cavity 148 at the bottom gap 156 is the light module 160. The light module 160 can be attached to the first inner major surface 107 and the second inner major surface 122 by any of a variety of fastening methods including clips and fasteners. The light module 160 occupies all or substantially all of the bottom gap 156 along the length of the luminaire 100 thereby enclosing the cavity 148 along the bottom gap 156.

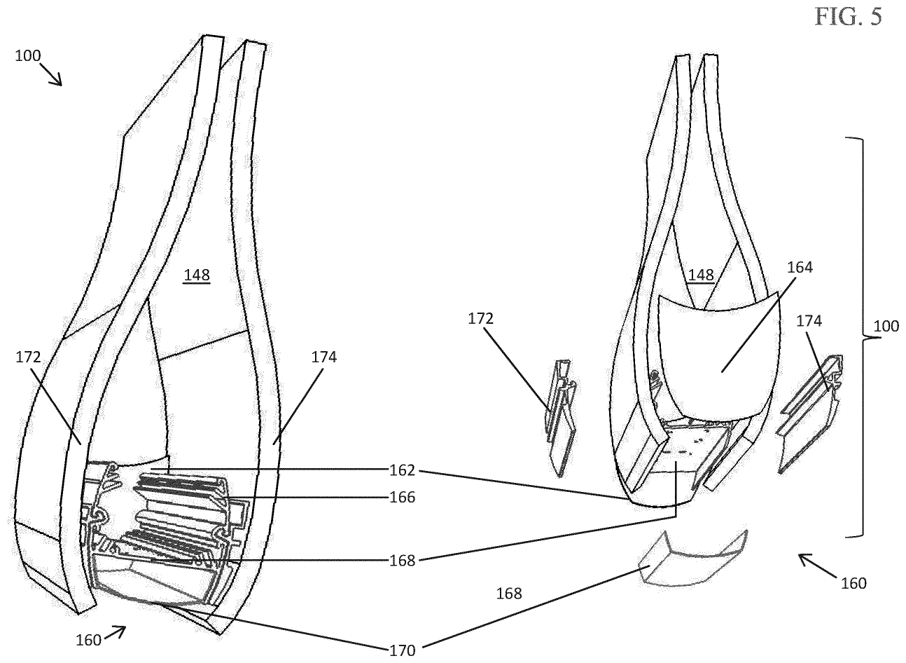

Referring to FIGS. 4 and 5, details of the light module 160 of example luminaire 100 are shown. As illustrated in the example of FIGS. 4 and 5, the light module 160 can comprise two side walls 172 and 174 that attach to the first acoustic panel 105 and second acoustic panel 120, respectively. Light module 160 further comprises an inner housing 166 that attaches to the side walls 172 and 174 on each side of the inner housing 166. The inner housing 166 comprises a horizontal panel 168 and a light source can be attached to the bottom side of the horizontal panel 168 thereby positioned to direct light downward. A lens cover 170 can attach to the inner housing 166 and be placed over the light source. The example light module 160 also comprises end caps 162 and 164.

The light source of the light module 160 can be in the form of a light emitting diode, an array of light emitting diodes, an organic LED, a fluorescent light source, a halogen light source, or some other type of light source. Certain light sources such as LED light sources and fluorescent light sources require regulated power and, in those cases, the light module 160 can receive regulated power from a power supply. As non-limiting examples, the power supply can comprise one or more of a driver, a ballast, a switched mode power supply, an AC to DC converter, a transformer, or a rectifier that can provide regulated power to the light source. Although not shown in FIGS. 4 and 5, the power supply can be located within the light module 160 and can receive AC power via a power cable that extends into the luminaire 100.

In another example, the power supply can be located remotely from the luminaire, such as in a plenum space above a ceiling from which the luminaire is suspended. The power supply can comprise class 1 connections for receiving power from a power source such as AC mains or grid power (e.g. 120 VAC, 230 VAC) from the electrical power grid or a renewable power source. The power supply can modify the power received from the power source and can comprise class 2 low voltage connections for coupling to a low voltage power cable. The low voltage power cable can supply low voltage power (e.g. 60 VDC or less) to the light module of the luminaire. In certain embodiments, the low voltage power cable can also be the suspension cable that suspends the luminaire from a ceiling or other structure. In other embodiments, the low voltage power cable can be attached to and run alongside the suspension cable that suspends the luminaire from a ceiling or other structure.

In certain example embodiments, the light module of the suspended luminaires described in this disclosure can use a lightguide for transmitting light. For example, in place of the horizontal panel 168, a lightguide can be positioned horizontally within the light module and at or proximal to the bottom gap 156. One advantage of positioning a lightguide horizontally within the light module is that it can provide light in both a downward direction and an upward direction through the top gap 150. A lightguide can comprise a panel, slab, plate, or related form that can be flat or curved and that comprises two major faces that are internally reflective. Light can be introduced into the lightguide from a first edge of the lightguide, so that the major faces guide the light towards a second edge. One or both of the major faces can have features that provide a controlled release of light flowing through the lightguide, to illuminate an area. Light can thus propagate in the lightguide via internal reflection from the two major faces, traveling from the light-source edge towards an opposing edge, and illumination light can escape from the lightguide through the major faces. A light source can be positioned adjacent the first edge of the lightguide, so that the light source emits light into the lightguide via the first edge. In alternative embodiments, additional LEDs can be located adjacent to one or more of the other edges of the lightguide thereby directing light into the lightguide from the other edges. In yet other alternative embodiments, instead of positioning LEDs adjacent to one or more edges of the lightguide, certain edges can have a reflector located adjacent to one or more edges of the lightguide, the reflector reflecting light exiting the edge of the lightguide back into the edge of the lightguide. In yet other alternative embodiments, the lightguide can have a circular or round shape with one continuous edge where LEDs are positioned along a portion of the lightguide edge and reflective material can be positioned along other portions of the lightguide edge. LEDs are an example of the light source that can be used with the lightguide, including but not limited to discrete LEDs, arrays of LEDs, and chip-on-board LEDs. In other embodiments, alternative light sources such as organic LEDs can be used.

In certain example embodiments, the example luminaires described herein are subject to meeting certain standards and/or requirements. For example, the National Electric Code (NEC), the National Electrical Manufacturers Association (NEMA), the International Electrotechnical Commission (IEC), the Federal Communication Commission (FCC), and the Institute of Electrical and Electronics Engineers (IEEE) set standards as to electrical enclosures (e.g., light fixtures), wiring, and electrical connections. As another example, Underwriters Laboratories (UL) sets various standards for light fixtures. Use of example embodiments described herein meet (and/or allow a corresponding device to meet) such standards when required.

Referring generally to the foregoing examples, any luminaire components (e.g., the light module, the acoustic panels), described herein can be made from a single piece (e.g., as from a mold, injection mold, die cast, 3-D printing process, extrusion process, stamping process, or other prototype methods). In addition, or in the alternative, a luminaire (or components thereof) can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to fixedly, hingedly, removeably, slidably, and threadably.

A fastener or attachment feature (including a complementary attachment feature) as described herein can allow one or more components and/or portions of an example luminaire to become coupled, directly or indirectly, to another portion or other component of a luminaire. An attachment feature can include, but is not limited to, a flange, a snap, Velcro, a clamp, a portion of a hinge, an aperture, a recessed area, a protrusion, a slot, a spring clip, a tab, a detent, and mating threads. A component can be coupled to a luminaire by the direct use of one or more attachment features.

In addition, or in the alternative, a portion of a luminaire can be coupled using one or more independent devices that interact with one or more attachment features disposed on the light fixture or a component of the light fixture. Examples of such devices can include, but are not limited to, a pin, a hinge, a fastening device (e.g., a bolt, a screw, a rivet), epoxy, glue, adhesive, tape, and a spring. One attachment feature described herein can be the same as, or different than, one or more other attachment features described herein. A complementary attachment feature (also sometimes called a corresponding attachment feature) as described herein can be a coupling feature that mechanically couples, directly or indirectly, with another coupling feature.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the scope of the following claims, the scope of which are to be accorded the broadest interpretation so as to encompass modifications and equivalent structures.

1. A luminaire comprising:
a first acoustic panel comprising a first inner major surface, a first outer major surface, a first top side, a first bottom side, a first proximal lateral side, and a first distal lateral side;
a second acoustic panel comprising a second inner major surface, a second outer major surface, a second top side, a second bottom side, a second proximal lateral side, and a second distal lateral side;
a top gap separating the first top side of the first acoustic panel and the second top side of the second acoustic panel, the first top side of the first acoustic panel and the second top side of the second acoustic panel being joined by a joining rod that is attached proximal to the first top side of the first acoustic panel and attached proximal to the second top side of the second acoustic panel;
a bottom gap separating the first bottom side of the first acoustic panel and the second bottom side of the second acoustic panel, the first bottom side of the first acoustic panel and the second bottom side of the second acoustic panel being joined by a light module that is attached proximal to the first bottom side of the first acoustic panel and attached proximal to the second bottom side of the second acoustic panel,
wherein the first acoustic panel has a first curved shape and the second acoustic panel has a second curved shape, the first curved shape being a mirror image of the second curved shape,
wherein the first acoustic panel, the second acoustic panel and the light module together define a cavity,
wherein one or more openings along the top gap permit sound to travel into the cavity,
wherein the cavity has varying widths, the top gap being the most narrow width of the cavity, and
wherein, in a downward direction from the top gap, the first acoustic panel and the second acoustic panel first curve outward until a major gap and then curve back inward until the bottom gap, the bottom gap being smaller than the major gap but larger than the top gap.

2. The luminaire of claim 1, wherein the first top side and the second top side are equidistant from each other along a length of the top gap.

3. The luminaire of claim 1, wherein the first bottom side and the second bottom side are equidistant from each other along a length of the light module

4. (canceled)

5. The luminaire of claim 1, wherein the first top side and the second top side are linear.

6. The luminaire of claim 1, wherein the first bottom side and the second bottom side are linear.

7. The luminaire of claim 1, wherein the first proximal lateral side, the first distal lateral side, the second proximal lateral side, and the second distal lateral side are curved.

8. (canceled)

9. The luminaire of claim 1, further comprising at least one suspension cable coupled to the at least one joining rod.

10. The luminaire of claim 9, wherein the at least one suspension cable is also a low voltage power cable adapted to deliver low voltage power to the light module.

11. The luminaire of claim 9, further comprising a low voltage power cable running along side a suspension cable of the at least one suspension cable, the low voltage power cable adapted to deliver low voltage power to the light module.

12. The luminaire of claim 1, wherein the light module comprises one or more LEDs.

13. The luminaire of claim 1, wherein the first acoustic panel comprises a first aperture that receives a first end of the at least one joining rod and the second acoustic panel comprises a second aperture that receives a second end of the at least one joining rod.

14. The luminaire of claim 1, wherein the at least one joining rod comprises a plurality of joining rods attached proximal to the first top side of the first acoustic panel and attached proximal to the second top side of the second acoustic panel.

15. The luminaire of claim 1, wherein the first acoustic panel and the second acoustic panel comprise PET that is shaped using heat to create the first curved shape and the second curved shape.
